(19) United States
(12) Patent Application Publication
(10) Pub. No.: US 2026/0307961 A1
(43) Pub. Date: Oct. 8, 2026

(54) CEILING MOUNTED STORAGE SYSTEM

(71) Applicant: OZIL LIFTS PTY LTD, Mooloolaba (AU)

(72) Inventor: Jacqueline Mary DUNN, Buderim, Queensland (AU)

(21) Appl. No.: 19/478,928

(22) PCT Filed: Apr. 23, 2024
(86) PCT No.: PCT/AU2024/050386

§ 371 Date: Oct. 27, 2025

(30) Foreign Application Priority Data
Apr. 28, 2023 (AU) 2023901256

(51) Int. Cl. B66F 7/02; A47B 46/00

(52) U.S. Cl. CPC B66F 7/02; A47B 46/00

(57) ABSTRACT

A ceiling mounted storage system for lifting objects stored on a platform, the system including a frame configured to be mounted to a ceiling of a building; a lifting subsystem attached to the frame and including a plurality of lifting tethers configured to be attached to the platform, the lifting subsystem being configured to move the platform between: a lowered position whereby a used can place the objects on the platform to be stored; and, a raised position whereby the objects can be stored on the platform proximate to the ceiling; and, a safety subsystem attached to the frame and including a plurality of safety tethers configured to be attached to the platform, the safety subsystem being configured to prevent lowering of the platform in the event of a failure in the lifting subsystem.

### BACKGROUND OF THE INVENTION

The present invention relates to a ceiling mounted storage system for lifting objects stored on a platform.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

WO 2008/124019 A1 discloses a movable storage system, and more particularly relates to a movable, modular storage system that attaches to the ceiling in a garage. The modular storage system can be lowered for easy access to items to be stored or removed from the storage system, can be raised up by using a retraction system.

U.S. Pat. No. 9,572,427 B2 discloses a motorized home storage system can be mounted to any type of ceiling for storing items off the ground. The motorized home storage system is designed to make use of unused ceiling space, allowing homeowners to store their items overhead and out of the way and create additional storage in homes. The system is designed for large and heavy items that can be easily stored due to the two tube motors. Tube motors can allow a storage platform to be lowered for easy access, loading, and unloading. Additionally, tube motors can allow the storage platform to be raised to the ceiling in order to be completely out of the way and off the ground. The system can include legs attached to the platform which can unsnap to turn the platform into a table.

Ceiling mounted storage systems of the types discussed above typically involve relatively heavy lifting mechanisms suspended from the ceiling. Where a lifting mechanism fails, it can place users or the user's property at risk. However, traditional storage systems as exemplified above have not adequately addressed potential failures of the lifting mechanisms. As such, the present invention seeks to improve the safety of ceiling mounted storage systems, or the like.

### SUMMARY OF THE PRESENT INVENTION

In one broad form, an aspect of the present invention seeks to provide a ceiling mounted storage system for lifting objects stored on a platform, the system including a frame configured to be mounted to a ceiling of a building; a lifting subsystem attached to the frame and including a plurality of lifting tethers configured to be attached to the platform, the lifting subsystem being configured to move the platform between: a lowered position whereby a used can place the objects on the platform to be stored; and, a raised position whereby the objects can be stored on the platform proximate to the ceiling; and, a safety subsystem attached to the frame and including a plurality of safety tethers configured to be attached to the platform, the safety subsystem being configured to prevent lowering of the platform in the event of a failure in the lifting subsystem.

In one embodiment, the events of failure in the lifting subsystem include at least one of: failure of a component of the lifting subsystem; failure of at least one of the plurality of lifting tethers; and, failure of an attachment of at least one of the lifting tethers to the platform.

In one embodiment, the safety subsystem is configured to independently lock each of the plurality of safety tethers in the event of a failure in the lifting subsystem.

In one embodiment, the independent locking of one of the safety tethers is triggered by one of: rapid movement of the safety tethers; and, rapid acceleration of the safety tethers.

In one embodiment, each of the plurality of safety tethers include a safety attachment point that is configured to attach to the platform.

In one embodiment, each of the plurality of lifting tethers include a lifting attachment point that is configured to attach to the platform.

In one embodiment, each of the safety attachment points are configured to be independently attached to the platform from each of the lifting attachment points.

In one embodiment, the safety subsystem includes a plurality of locking mechanisms that are configured to hold the safety tethers at a fixed length and/or position to prevent lowering of the platform in the event of a failure in the lifting subsystem.

In one embodiment, each of the plurality of locking mechanisms are inertial locking mechanisms.

In one embodiment, the inertial locking mechanisms are at least one of: a seatbelt arrester; and, a rotary locking mechanism.

In one embodiment, each of the plurality of safety tethers extend and/or retract on a respective safety tether spools.

In one embodiment, each safety tether spool is configured to: permit the respective safety tether to extend during controlled lowering of the platform using the lifting subsystem; and, automatically retract the respective safety tether during raising of the platform using the lifting subsystem.

In one embodiment, for each of the plurality of lifting tethers there is a corresponding safety tether.

In one embodiment, the plurality of lifting tethers are steel wire cables; and, the plurality of safety tethers are belts.

In one embodiment, the lowered position is proximate to a floor of the building.

In one embodiment, the lifting subsystem includes a motor that is configured to move the platform between the lowered position and the raised position.

In one embodiment, the motor is at least one of: coupled to the lifting subsystem using a worm drive; a DC motor; and, an AC motor.

In one embodiment, the motor includes motor circuitry, wherein the motor monitors the current in the motor circuitry and stops the motor if the motor detects excess current in the motor circuitry.

In one embodiment, the motor detects excess current in the motor circuitry when the motor detects a current in the motor circuitry that is 30 A or more.

In one embodiment, the motor is configured to rotate a rotary drive, wherein the rotary drive is configured to move the platform between the lowered position and the raised position.

In one embodiment, the plurality of lifting tethers are attached to the rotary drive, wherein when: the rotary drive rotates in a first direction, the lifting tethers are configured to retract to thereby lift the platform; and, the rotary drives in a second direction, the lifting tethers are configured to extend to thereby lower the platform.

In one embodiment, the rotary drive includes a lifting tether spool, the plurality of lifting tethers extending and/or retracting from the lifting tether spool in use.

In one embodiment, a coupling connector is connected to the lifting subsystem, wherein operating the coupling connector is configured to raise and/or lower the platform.

In one embodiment, the coupling connector is connected to the rotary drive, wherein the coupling connector is configured so that a user can operate the coupling connector to raise and/or lower the platform while the motor is deactivated.

In one embodiment, the coupling connector is configured to raise and/or lower the platform using at least one of: a manual operator; an electrical operator; an externally powered electrical operator; and, an electric drill.

In one embodiment, the safety subsystem includes at least one limit switch and a limit switch bracket, wherein when the limit switch contacts the limit switch bracket the limit switch is configured to halt the motor.

In one embodiment, the limit switch is attached to the frame and the at least one limit switch bracket is attached to at least one of the lifting tethers, wherein as the lifting subsystem lifts the platform above a pre-set raised position, the at least one limit switch contacts the limit switch bracket and halts the motor to prevent the platform from being lifted further.

In one embodiment, the limit switch is attached to the frame and the at least one limit switch bracket is attached to at least one of lifting tethers, wherein as lifting subsystem lowers the platform below a pre-set lowered position, the at least one limit switch contacts the limit switch bracket and halts the motor to prevent the platform from being lowered further.

In one embodiment, the lifting subsystem includes a first limit switch, a second limit switch and a limit switch bracket, wherein: as the lifting subsystem lifts the platform above a pre-set raised position, the first limit switch contacts the limit switch bracket and halts the motor to prevent the platform from being lifted further; and, as the lifting subsystem lowers the platform below a pre-set lowered position, the second limit switch contacts the limit switch bracket and halts the motor to prevent the platform from being lowered further.

In one embodiment, the contact between the limit switch and limit switch bracket creates an electrical signal that is sent to the motor which prevents the lifting subsystem from raising the platform above a pre-set raised position or lowing the platform below a pre-set lowered position.

In one embodiment, the safety subsystem includes a rotary switch that is attached to at least one of the lifting tethers, wherein: as the lifting subsystem lifts the platform above a pre-set raised position, the rotary switch halts the motor to prevent the platform from being lifted further; and, as the lifting subsystem lowers the platform below a pre-set lowered position, the rotary switch halts the motor to prevent the platform from being lowered further.

In one embodiment, as the rotary switch rotates beyond a pre-set number of rotations in a first direction, the rotary switch creates an electrical signal that is sent to the motor which prevents the platform from being lifted further; and, as the rotary switch rotates beyond a pre-set number of rotations in a second direction, the rotary switch creates an electrical signal that is sent to the motor which prevents the platform from being lowered further.

In another broad form, an aspect of the present invention seeks to provide a ceiling mounted storage system for lifting objects stored on a platform, the system including: the platform; a frame configured to be mounted to a ceiling of a building; a lifting subsystem attached to the frame and including a plurality of lifting tethers attached to the platform, the lifting subsystem being configured to move the platform between: a lowered position whereby a user can place the objects on the platform to be stored; and, a raised position whereby the objects can be stored on the platform proximate to the ceiling; and, a safety subsystem attached to the frame and including at least some of the plurality of safety tethers attached to the platform, the safety subsystem being configured to prevent lowering of the platform in the event of a failure in the lifting subsystem.

In one embodiment, the platform includes a plurality of holes.

In one embodiment, the platform is configured to include: a plurality of lifting attachment points corresponding to the plurality of lifting tethers; and, a plurality of safety attachment points corresponding to the plurality of safety tethers.

It will be appreciated that the broad forms of the invention can be used in conjunction and/or independently, and reference to separate broad forms in not intended to be limiting.

### BRIEF DESCRIPTION OF THE DRAWINGS

An example of the present invention will now be described with reference to the accompanying drawings, in which:

FIG. 1 is an isometric drawing of a storage system;

FIG. 2 is a side view of a storage system;

FIG. 3A is a section B-B cut of FIG. 2;

FIG. 3B is a detailed view of FIG. 3A;

FIG. 4A is a section A-A cut of FIG. 2;

FIG. 4B is a section C-C cut of FIG. 4A;

FIG. 5A is an isometric drawing of a storage system;

FIG. 5B is an isometric drawing of a storage system; and,

FIG. 6 is a detailed view of FIG. 5A.

### DETAILED DESCRIPTION OF THE PREFERRED EMBODIMENTS

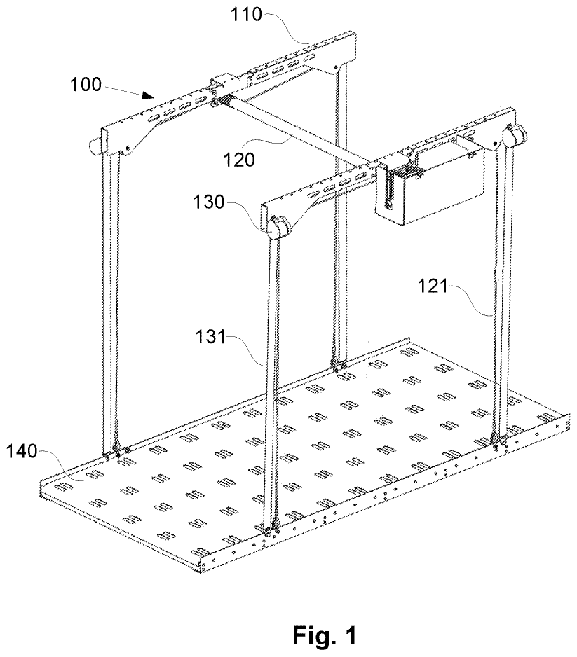

An example of ceiling mounted storage system for lifting objects stored on a platform will be described with reference to FIG. 1.

In this example, the system 100 includes a frame 110, a lifting subsystem 120 and a safety subsystem 130. The frame 110 is configured to be mounted to a ceiling of a building and allows the system 100 to be installed in a stable manner. The lifting subsystem 120 and safety subsystem 130 are attached to the frame 110.

The lifting subsystem 120 includes a plurality of lifting tethers 121 configured to be attached to a platform 140. While the lifting tethers 121 are attached to the platform 140, the lifting subsystem 120 is configured to be able move between at least two positions, being a lowered position whereby a user can place objects on the platform 140 for them to be subsequently stored, and a raised position whereby the objects can be stored on the platform 140 proximate to the ceiling.

FIG. 1 shows an example of the lifting subsystem 120 in a lowered position, allowing a user to place objects onto the platform 140 with ease before the lifting subsystem 120 can raise the platform 140 to a raised position to store the objects. The lowered position may be proximate to a floor of the building. A person skilled in the art will appreciate that the position shown in FIG. 1 is merely one example of the lowered position.

The raised position may be selected so that the platform 140 is separated from the ceiling by a sufficient distance to allow room for the objects to be stored on the platform 140 without interference with the ceiling, whilst allowing use of the space below the ceiling while the platform 140 is overhead. For example if the system 100 is mounted on the ceiling in a garage, the raised position may be selected to allow a vehicle to be parked underneath the platform 140 without interference.

The safety subsystem 130 includes a plurality of safety tethers 131 configured to be attached to the platform 140. The safety subsystem 130 is configured to prevent lowering of the platform 140 in the event of a failure in the lifting subsystem 120.

Conventional ceiling mounted storage systems can pose a risk to users, particularly if there is a failure in its lifting mechanism. Should there be a failure in the lifting mechanism, the platform and objects stored thereon of a conventional ceiling mounted storage system may simply fall from an elevated position in an uncontrolled manner, potentially colliding with humans or inflicting severe damage to property (for example, a vehicle parked underneath the storage system). In this example, the potential risk is mitigated through the inclusion of a safety subsystem 130 that acts to prevent the platform 140 from falling, and potentially injuring/causing damage, in the event that the lifting subsystem 120 experiences a failure.

The lifting subsystem 120 may experience an event of failure in a number of ways. For example, a failure may occur in a component of the lifting subsystem 120, in one or more of the lifting tethers 121, or their attachment to the platform 140, which would otherwise allow the platform 140 to fall in the absence of the safety subsystem 130.

The safety subsystem is configured to independently lock each of the plurality of safety tethers 131 in the event of a failure in the lifting subsystem 120. Since the safety tethers 131 can be independently locked, it allows the safety subsystem 130 to safely manage failures in the lifting subsystem 120 without unnecessarily restricting ordinary operation of the system 100. The independent locking of one of the safety tethers 131 may be triggered by one of rapid movement of the safety tethers and rapid acceleration of the safety tether.

In a first example of operation of the system 100, the lifting subsystem 120 is subject to a catastrophic failure where the lifting subsystem 120 is incapable of holding the platform 140 in a safe manner using any of the lifting tethers 121. Where such a catastrophic failure occurs, all of the safety tethers 131 may lock to prevent the platform 140 from falling in a dangerous manner. In a second example, the lifting subsystem 120 is subject to a minor failure in which one of the lifting tethers 121 breaks, which still allows for the platform 140 to be raised and lowered, but increases the risk of a catastrophic failure. In the second example, one or more of the safety tether 131 will lock as required to prevent inadvertent lowering of the platform 140.

Furthermore, the independent locking of each safety tether 131 allows for additional redundancy in the safety subsystem 130. If a first safety tether 131 fails to lock (i.e. due to a mechanical failure in the locking mechanism), then a second safety tether 131 can instead lock independently of the first safety tether 131 to prevent further unsafe lowering of the platform 140 that is not otherwise prevented due to the failure of the first safety tether 131.

In one example, for each of the plurality of lifting tethers 121 there is a corresponding safety tether 131. As discussed above, the lifting subsystem 120 may be subject to a minor failure in which one of the lifting tethers 121 breaks. By pairing each of the lifting tethers 121 with a corresponding safety tether 131, it allows the safety subsystem 130 to prevent inadvertent lowering of the platform 140 irrespective of which lifting tether 121 fails. It will be appreciated that the safety tethers 131 in such an example will provide one-to-one redundancy for the lifting tethers 121.

In one example, each of the plurality of safety tethers 131 include a safety attachment point that is configured to attach to the platform 140. Additionally, each of the lifting tethers 121 may include a lifting attachment point that is configured to be attached to the platform 140. Each of the safety attachment points may be configured to be independently attached to the platform 140 from each of the lifting attachment points.

In one example, the safety subsystem 130 includes a plurality of locking mechanisms that are configured to hold the safety tethers 131 at a fixed length and/or position to prevent lowering of the platform in the event of a failure in the lifting subsystem 120. In some embodiments, each of the plurality of locking mechanisms may be inertial locking mechanisms. For instance, the inertial locking mechanism may be implemented using a seatbelt arrester or a rotary locking mechanism.

In combination with the safety tethers 131, the plurality of locking mechanisms act to prevent the platform 140 from falling in a dangerous manner in the event of a failure in the lifting subsystem 120 by holding the safety tethers 131 at a fixed length, which then prevent the platform 140 from falling. Where the locking mechanisms are inertial locking mechanisms, this allows the safety tethers 131 to be held in a fixed length without input from an operator or an electronic system as an inertial locking mechanism can be configured to lock in response to rapid movement/acceleration through a purely mechanical device—thereby reducing the cost and complexity of the safety subsystem 130. In some embodiments, the inertial locking mechanisms may be formed using a commercially available seatbelt arrester or rotary locking mechanism, allowing a person skilled in the art to implement an inertial locking mechanism in a simple and effective manner.

In some examples, each of the plurality of safety tethers 131 extend and/or retract on a respective safety tether spools. In one implementation, each safety tether spool is configured to permit the respective safety tether 131 to extend during controlled lowering of the platform 140 using the lifting subsystem 120, and automatically retract the respective safety tether 131 during raising of the platform 140 using the lifting subsystem 120. Each safety tether spool may also incorporate a locking mechanism as discussed above. It will be appreciated that this functionality can be provided by a commercially available self-retracting seatbelt arrester.

In one example, the plurality of lifting tethers 121 are steel wire cables and the plurality of safety tethers 131 are belts. However, it will be appreciated that this is not essential, such that the lifting tethers 121 and the safety tethers 131 may be provided in any suitable form while providing the core functionality as discussed above.

In one example, the lifting subsystem 120 includes a motor that is configured to move the platform 140 between the lowered position and the raised position. Additionally, the motor may be configured to rotate a rotary drive that is configured to move the platform 140 between the lowered position and the raised position. Further, the plurality of lifting tethers 121 may be attached to the rotary drive, wherein when the rotary drive rotates in a first direction, the lifting tethers 121 are configured to retract to thereby lift the platform 140; and when the rotary drives rotates in a second direction, the lifting tethers 121 are configured to extend to thereby lower the platform. In one example, the rotary drive 120 includes a lifting tether spool, whereby the plurality of lifting tethers 121 extend and/or retract from the lifting tether spool. Depending on the implementation of the invention by the person skilled in the art, the motor can be integrated into the lifting subsystem 120 itself or more directly to the lifting tethers 131 by using a rotary drive to enable the lowering and lifting of the platform 140.

The inclusion of a motor allows the platform 140, and the potentially heavy objects stored on the platform 140, to be consistently lifted and lowered in a safe manner. The use of a motor allows for more consistent forces to be placed on the lifting subsystem 120 and will extend the lifespan of a number of components, further reducing the possibility of failures within the lifting subsystem 120. The inclusion of a rotary drive can also reduce the number of moving parts required to lower and raise the platform 140. The rotary drive allows all of the lifting tethers 121 to be attached to a single moving drive, where moving the drive in a first/second direction allows the platform 140 to be lowered/raised without significant additional moving parts, also reducing the possibility of failure in the lifting subsystem 120.

In one example, the motor is coupled to the lifting subsystem 120 using a worm drive. The inclusion of a worm drive further reduces safety risks, as the high gear ratio when using a worm drive acts as a self-locking/braking mechanism which can prevent the platform 140 from accidental dropping.

Further, the motor may be a DC motor. DC motors are capable of producing high torque levels, even at zero revs, which allows the motor to provide sufficient torque to drive the rotary drive/lifting subsystem 120 even when the motor is idling. Preferably, the motor may be a 24V DC motor, but a person skilled in the art would appreciate that a number of different DC motors could be used as suitable to the implementation of the invention. For example, in other embodiments, the motor may be an AC motor.

In one example, the motor includes motor circuitry, wherein the motor monitors the current in the motor circuitry and stops the motor if the motor detects excess current in the motor circuitry. Further, the motor may detect that there is excess current in the motor circuitry, for example when the motor detects a current in the motor circuitry that is 30 A or more. The lifting subsystem 120 may be configured to hold a large number of potentially heavy objects, thereby placing additional strain on the motor when lifting or raising the platform 140. By monitoring the current in the motor circuitry and stopping the motor when the current hits an excess level, the motor can be prevented from being run at a damaging or dangerous current level.

In one example, a coupling connector is connected to the lifting subsystem 120, wherein operating the coupling connector is configured to raise and/or lower the platform 140 independently of the motor. The coupling connector may be connected to the rotary drive, and the coupling connector may be configured so that a user can operate the coupling connector to raise and/or lower the platform 140 even while the motor is deactivated. The coupling connector can be used instead of the motor where the motor is incapable, or prevented from, lowering or raising the platform 140. For example, if there is a power outage that prevents the motor from running, the coupling connector can be used instead.

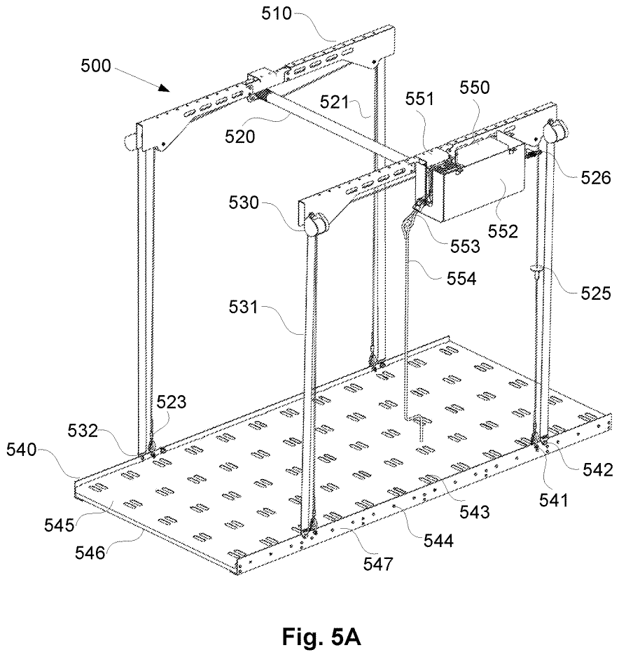

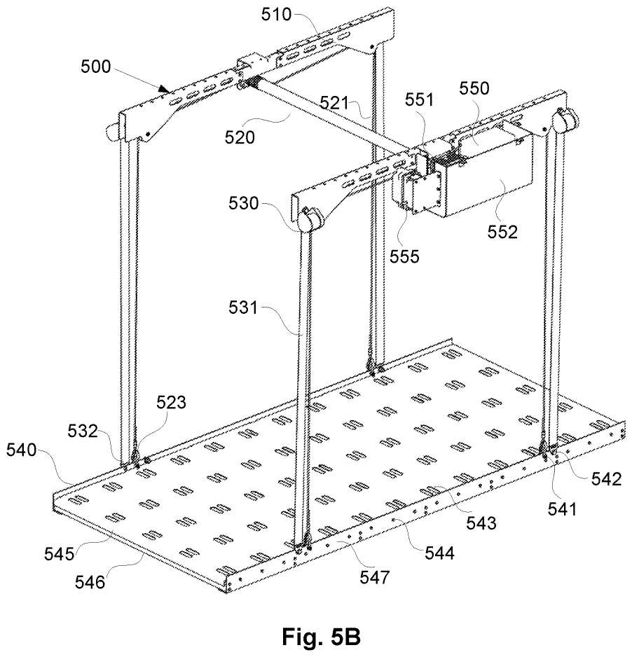

Additionally, the coupling connector may be configured to raise and/or lower the platform 140 using any one of a manual operator, an electrical operator, an externally powered electrical operator and an electric drill. The variation in configurations allows a person skilled in the art to introduce a suitable mechanism to lower or raise the platform 140 where the motor is not operating or insufficient. Examples of implementations including such a coupling connector will be described with reference to FIGS. 5A and 5B, in due course.

In one example, the safety subsystem 130 includes at least one limit switch and a limit switch bracket, wherein when the limit switch contacts the limit switch bracket the limit switch is configured to halt the motor. Additionally, the limit switch may be attached to the frame 110 and the at least one limit switch bracket is attached to at least one of lifting tethers 121, wherein as the lifting subsystem 120 lifts the platform 140 above a pre-set raised position, the at least one limit switch contacts the limit switch bracket and halts the motor to prevent the platform 140 from being lifted further. Further, the limit switch may be attached to the frame 110 and the at least one limit switch bracket is attached to at least one of lifting tethers 121, wherein as the lifting subsystem 120 lowers the platform 140 below a pre-set lowered position, the at least one limit switch contacts the limit switch bracket and halts the motor to prevent the platform 140 from being lowered further.

The combination of a limit switch and limit switch bracket creates safe operating window for the system 100, which allows the operator to raise and lower the platform 140 without concern for damage the system 100 or the operator's surroundings. In a first example, the operator may be lowering the platform 140 without observing that the platform 140 is close to hitting the floor. Before the platform 140 hits the floor, potentially damaging the platform 140 or the floor, the limit switch on the lifting tether 121 contacts the limit switch bracket on the frame 110 which sends a signal to the motor to prevent the motor from lowering the platform 140 any further. In a second example, the operator may be raising the platform 140 without observing that the platform 140 is close to hitting the frame 110. Before the platform 140 hits the frame 110, potentially damaging the platform 140 or the frame 110, the limit switch on the lifting tether 121 contacts the limit switch bracket on the frame 110 which sends a signal to the motor to prevent the motor from raising the platform 140 any further.

A person skilled in the art would also understand that the positioning of the limit switch and the limit switch bracket will depend on the size/height of the system 100. Furthermore, in some implementations, the positioning may be adjustable depending on the specific installation of the system 100, for instance to accommodate different ceiling heights or to allow for different sizes of objects to be stored on the platform 140.

In one example, the lifting subsystem 120 includes a first limit switch and a second limit switch and a limit switch bracket wherein as the lifting subsystem lifts the platform above a pre-set raised position, the first limit switch contacts the limit switch bracket and halts the motor to prevent the platform from being lifted further and as the lifting subsystem lowers the platform below a pre-set lowered position, the second limit switch contacts the limit switch bracket and halts the motor to prevent the platform from being lowered further. As described above, the limit switches and limit switch bracket allow for the operation of the system 100 without the operator's full attention. By including multiple limit switches, this allows the lifting subsystem 120 to prevent dangerous lifting/lowering at the same time.

Alternatively, a person skilled in the art would understand that the limit switch and switch bracket and the first limit switch, second limit switch and switch bracket could be replaced with a rotary switch. The use of a rotary switch allows the lifting subsystem 120 to prevent the platform 140 from being lifted/lowered below the pre-set raised/lowered positions, and the rotary switch can be provided within a single housing rather than requiring limit switches in separate positions. Once the rotary switch has rotated beyond a pre-set number of rotations in a first or second direction, the rotary switch creates an electrical signal that is sent to the motor which prevents the platform from being lifted or lowered further. Therefore, the use of a rotary switch can allow for similar levels of safety as the limit switch and limit switch bracket arrangement, while housing the necessary components in a more compact form.

In one example, the platform 140 includes a plurality of holes. Additionally, each of the plurality of holes can be in the form of any one of a circle, an extended circle, an ellipse, a square or a rectangle. The inclusion of holes in the platform 140 may allow for the weight of the platform 140 to be minimised and thereby increase the object lifting capacity of the system140. The holes may also allow for undesired fluids to be removed from the platform 140 in a passive manner. For example, the system 100 is installed in a garage that has a leaking roof where during storms water leaks from the roof onto the platform 140. If the platform 140 did not include holes, the water could build up and cause damage to the objects stored on the platform 140. By including a plurality of holes, water can flow off the platform 140 before it builds up sufficiently to damage objects stored on the platform 140.

In one example, the platform 140 is configured to include a plurality of lifting attachment points corresponding to the plurality of lifting tethers 121 and a plurality of safety attachment points corresponding to the plurality of safety tethers 131. Separating the lifting and safety attachment points improves the reliability of the system 100. One of the points of failure for the lifting subsystem 120 is the physical connection between the lifting subsystem 120 and the platform 140, and separating the safety attachment point and the lifting attachment point prevents failure in the lifting attachment point from damaging the safety attachment point, thereby improving reliability of the safety subsystem 130 and the system 100.

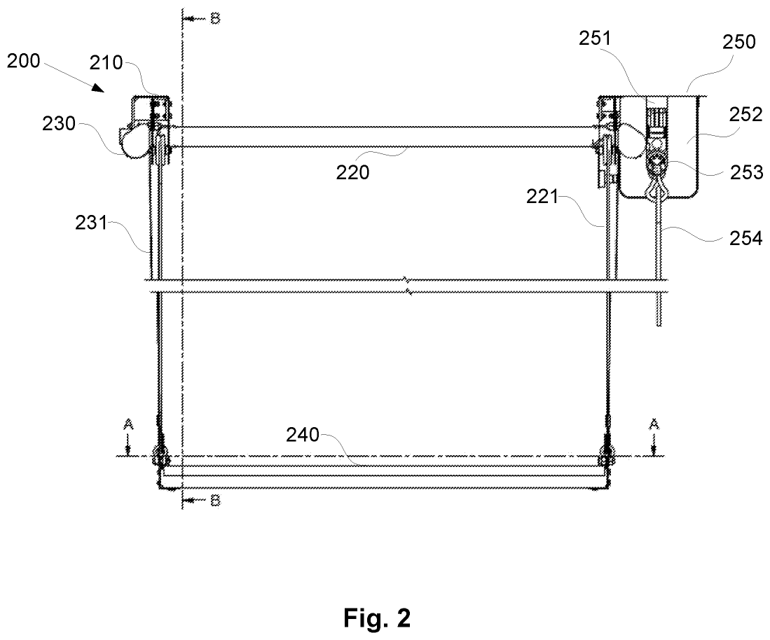

An example of ceiling mounted storage system suitable for lifting objects stored on a platform will be described with reference to FIG. 2.

In this example, the system 200 includes a frame 210, a lifting subsystem 220, a safety subsystem 230 and a motor subsystem 250.

The frame 210 is configured to be mounted to a ceiling of a building and allows the system 200 to be installed in a stable manner. The lifting subsystem 220, safety subsystem 230 and the motor subsystem 250 are attached to the frame 210. These elements of the system 200 have functionalities similar to the corresponding elements of the example system 100 discussed above, albeit with any additional or different functionalities being described below.

The lifting subsystem 220 includes a plurality of lifting tethers 221 configured to be attached to a platform 240. While the lifting tethers 221 are attached to the platform 240, the lifting subsystem 220 is configured to be able move between at least two positions, namely a lowered position, whereby a user can place objects on the platform 240 for them to be subsequently stored, and a raised position whereby the objects can be stored on the platform 240 proximate to the ceiling.

FIG. 2 shows an example of the lifting subsystem 220 in a lowered position, allowing a user to place objects onto the platform 240 with ease before the lifting subsystem 220 can raise the platform 240 to a raised position to store the objects. A person skilled in the art will appreciate that the position shown in FIG. 2 is merely one example of the lowered position.

The safety subsystem 230 includes a plurality of safety tethers 231 configured to be attached to the platform 240. The safety subsystem 230 is configured to prevent lowering of the platform 240 in the event of a failure in the lifting subsystem 220.

The motor subsystem 250 includes a motor 251, a motor case 252, a manual operator connector 253 and a manual operator 254. The motor subsystem 250 is configured to connect to the lifting subsystem 220 to extend/retract the lifting tethers 221 so that the platform 240 can be lowered/raised.

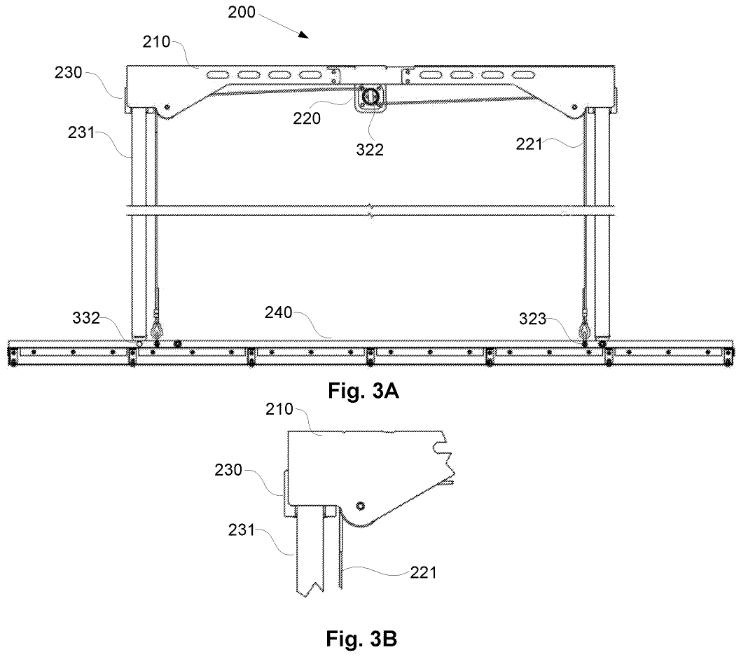

Further details of the ceiling mounted storage system 200 will be described with reference to FIGS. 3A and 3B.

As discussed above with reference to FIG. 2, the system 200 includes a frame 210, a lifting subsystem 220 and a safety subsystem 230. The lifting subsystem 220 includes a plurality of lifting tethers 221 configured to be attached to a platform 240. While the lifting tethers 221 are attached to the platform 240, the lifting subsystem 220 is configured to be able move between at least two positions.

The lifting subsystem 220 lowers/raises the platform 240 by extending/retracting the lifting tethers 221. The lifting tethers 221 are attached to a rotary drive 322, wherein the rotary drive 322 can rotate in a first and second direction. When the rotary drive 322 rotates in a first direction, the lifting tethers 221 are extended which allows the platform 240 to be lowered. When the rotary drive 322 rotates in a second direction, the lifting tethers are retracted which allows the platform 240 to be raised.

The safety subsystem 330 includes a plurality of safety tethers 231 configured to be attached to the platform 240. The safety subsystem 230 is configured to prevent lowering of the platform 240 in the event of a failure in the lifting subsystem 220.

The lifting tethers 221 are configured to be attached to the platform 240 through a plurality of lifting attachment points 323. The safety tethers 231 are configured to be attached to the platform 240 a plurality of safety attachment points 332. While FIG. 3A shows that the lifting attachment points 323 and safety attachment points 332 are independent, a person skilled in the art would appreciate that the lifting attachment points 323 and the safety attachment points 332 are not necessarily independent.

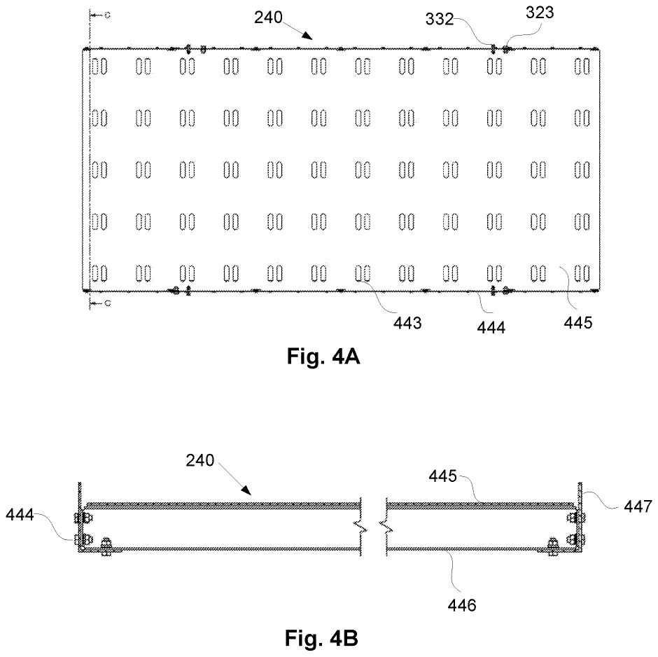

Further details of the platform 240 of the example of FIG. 2 will be described with reference to FIGS. 4A and 4B.

In this example, the platform 240 includes a platform plate 445 that is supported by platform cross members 446 extending between platform side frames 447.

The platform plate 445, the platform cross members 446 and the platform side frames 447 are attached together by bolts 444. The platform plate 445 includes a plurality of holes 443 and the platform side frames 447 include safety attachment points 332 and lifting attachment points 323 as discussed above.

The above discussed arrangement allows for more efficient construction of the platform 440. As the platform plate 445 is configured to hold the objects themselves, the platform cross members 446 support the platform plate 445, and the platform side frames 447 are configured to be attached to the safety tethers (not shown) and lifting tethers (not shown), this allows the different elements of the platform 240 to be formed with thin-walled structural elements, reducing construction costs.

An example of ceiling mounted storage system suitable for lifting objects stored on a platform will be described with reference to FIGS. 5A and 5B.

In this example, the system 500 includes a frame 510, a lifting subsystem 520, a safety subsystem 530 and a motor subsystem 550. The frame 510 is configured to be mounted to a ceiling of a building and allows the system 500 to be installed in a stable manner. The lifting subsystem 520, safety subsystem 530 and the motor subsystem 550 are attached to the frame 510.

The lifting subsystem 520 includes a plurality of lifting tethers 521 configured to be attached to a platform 540. While the lifting tethers 521 are attached to the platform 540, the lifting subsystem 520 is configured to be able move between at least two positions, namely, a lowered position, whereby a user can place objects on the platform 540 for them to be subsequently stored, and a raised position whereby the objects can be stored on the platform 540 proximate to the ceiling.

FIG. 5A shows an example of the lifting subsystem 520 in a lowered position, allowing a user to place objects onto the platform 540 with ease before the lifting subsystem 520 can raise the platform 540 to a raised position to store the objects. A person skilled in the art will appreciate that the position shown in FIG. 5A is merely one example of the lowered position.

The lifting subsystem 520 also includes a limit switch subsystem, which further includes a limit switch 525 and a limit switch bracket 526. The limit switch 525 is attached to one of the lifting tethers 521 and the limit switch bracket 526 is attached to the frame 510. The limit switch subsystem prevents the lifting subsystem 520 from moving when the limit switch 525 comes into contact with the limit switch bracket 526. This contact creates an electrical signal that is sent to a motor 551 which prevents the lifting subsystem 520 from raising the platform 540 above a pre-set acceptable limit.

The safety subsystem 530 includes a plurality of safety tethers 531 configured to be attached to the platform 540. The safety subsystem 530 is configured to prevent lowering of the platform 540 in the event of a failure in the lifting subsystem 520.

The platform 540 includes flange platform plate 545 that is supported by platform cross members 546 extending between platform side frames 547. The platform plate 545, the platform cross members 546 and the platform side frames 547 are attached together by bolts 544. The flange platform plate 545 includes a plurality of holes 543.

The lifting tethers 521 and the safety tethers 531 are connected to the platform 540 through the lifting attachment points 523 and the safety attachment points 532 respectively.

The motor subsystem 550 includes a motor 551, a motor case 552, a manual operator connector 553 and a manual operator 554. The motor subsystem 550 is configured to connect to the lifting subsystem 520 to extend/retract the lifting tethers 521 so that the platform 540 can be lowered/raised. The manual operator connector 553 and the manual operator 554 allow a user to manually lower/raise the platform 540 independently of the motor 551, for example in the event of failure of the motor 551 or loss of power supply to the motor.

The lifting subsystem 520 lowers/raises the platform 540 by extending/retracting the lifting tethers 521. The lifting tethers 521 are attached to a rotary drive 522, wherein the rotary drive 522 can rotate in a first and second direction. When the rotary drive 522 rotates in a first direction, the lifting tethers 521 are extended which allows the platform 540 to be lowered. When the rotary drive 522 rotates in a second direction, the lifting tethers are retracted which allows the platform 540 to be raised.

The lifting tethers 521 are configured to be attached to the platform 540 through a plurality of lifting attachment points 523. The safety tethers 531 are configured to be attached to the platform 540 a plurality of safety attachment points 532. While FIG. 5 shows that the lifting attachment points 523 and safety attachment points 532 are independent, a person skilled in the art would appreciate that the lifting attachment points 523 and the safety attachment points 532 are not necessarily independent.

FIG. 5B shows an alternative arrangement to FIG. 5A, and shares the frame 510, lifting subsystem 520, safety subsystem 530, tray 540 and motor subsystem 550 from FIG. 5A.

The motor subsystem 550 includes a coupling connector 555 connected to the motor casing 552, which can be configured to raise or lower the platform 540 should the motor be deactivated or insufficient. In this example, the coupling connector 555 is configured to allow a user to operate the lifting subsystem 520 using an electric drill or the like. The coupling connector 555 may resemble a drill bit shank such that it may be received in a chuck of an electric drill, to allow electrically powered operation of the lifting subsystem 520 independently of the motor 550 (in contrast to manual operation as in the example of FIG. 5A).

In this example, the lifting subsystem 520 includes a rotary switch (not shown) which can be configured to prevent the platform 540 from being raised above a pre-set raised position and lowered below a pre-set lowered position. Once the rotary switch has rotated beyond a pre-set number of rotations (which is analogous to the platform 540) being raised or lowered beyond the pre-set acceptable limits), the rotary switch creates an electrical signal that is sent to the motor 551 which prevents the lifting subsystem 520 from raising or lowered the platform 540 past the pre-set acceptable limits. It will be appreciated that such a rotary switch may replace the functionality of the limit switches discussed herein.

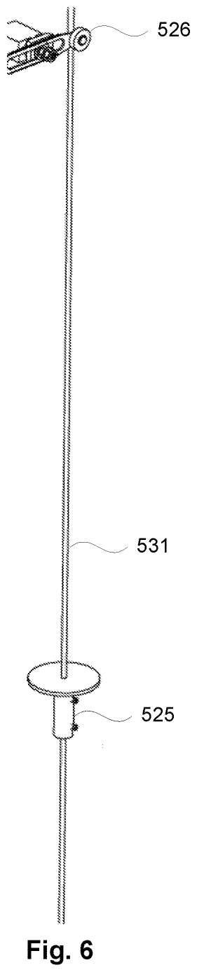

An example of a limit switch subsystem will be described with reference to FIG. 6.

In this example, the limit switch subsystem includes a limit switch 525 and a limit switch bracket 526. The limit switch 525 is attached to one of the lifting tethers 521 and the limit switch bracket 526 is attached to the frame (not shown). The limit switch subsystem prevents the lifting subsystem (not shown) when the limit switch 525 comes into contact with the limit switch bracket 526. This contact creates an electrical signal that is sent to the motor (not shown) which prevents the lifting subsystem from raising the platform (not shown) above a pre-set acceptable limit.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means ±20%.

Persons skilled in the art will appreciate that numerous variations and modifications will become apparent. All such variations and modifications which become apparent to persons skilled in the art, should be considered to fall within the spirit and scope that the invention broadly appearing before described.

1. A ceiling mounted storage system for lifting objects stored on a platform, the system including:
a) a frame configured to be mounted to a ceiling of a building;
b) a lifting subsystem attached to the frame and including a plurality of lifting tethers configured to be attached to the platform, the lifting subsystem being configured to move the platform between:
i) a lowered position whereby a user can place the objects on the platform to be stored; and,
ii) a raised position whereby the objects can be stored on the platform proximate to the ceiling; and,
c) a safety subsystem attached to the frame and including a plurality of safety tethers configured to be attached to the platform, the safety subsystem being configured to prevent lowering of the platform in the event of a failure in the lifting subsystem.

2. A system according to claim 1, wherein the events of failure in the lifting subsystem include at least one of:
a) failure of a component of the lifting subsystem;
b) failure of at least one of the plurality of lifting tethers; and,
c) failure of an attachment of at least one of the lifting tethers to the platform.

3. A system according to claim 1, wherein at least one of the following is true:
a) the safety subsystem is configured to independently lock each of the plurality of safety tethers in the event of a failure in the lifting subsystem; and
b) the independent locking of one of the safety tethers is triggered by one of:
i) rapid movement of the safety tethers; and
ii) rapid acceleration of the safety tethers.

4. (canceled)

5. A system according to claim 1, wherein at least one of the following is true:
a) each of the plurality of safety tethers include a safety attachment point that is configured to attach to the platform;
b) each of the plurality of lifting tethers include a lifting attachment point that is configured to attach to the platform; and
c) each of the safety attachment points are configured to be independently attached to the platform from each of the lifting attachment points.

6-7. (canceled)

8. A system according to claim 1, wherein the safety subsystem includes a plurality of locking mechanisms that are configured to hold the safety tethers at a fixed length and/or position to prevent lowering of the platform in the event of a failure in the lifting subsystem.

9. A system according to claim 8, wherein at least one of the following is true:
a) each of the plurality of locking mechanisms are inertial locking mechanisms; and
b) the inertial locking mechanisms are at least one of:
i) a seatbelt arrester; and
ii) a rotary locking mechanism.

10. (canceled)

11. A system according to claim 1, wherein at least one of the following is true:
a) each of the plurality of safety tethers extend and/or retract on a respective safety tether spool, and
b) each safety tether spool is configured to:
i) permit the respective safety tether to extend during controlled lowering of the platform using the lifting subsystem; and
ii) automatically retract the respective safety tether during raising of the platform using the lifting subsystem.

12. (canceled)

13. A system according to claim 1, wherein at least one of the following is true:
a) for each of the plurality of lifting tethers there is a corresponding safety tether;
b) the plurality of lifting tethers are steel wire cables; and
c) the plurality of safety tethers are belts.

14-15. (canceled)

16. A system according to claim 1, wherein the lifting subsystem includes a motor that is configured to move the platform between the lowered position and the raised position, and wherein the motor is at least one of:
a) coupled to the lifting subsystem using a worn drive;
b) a DC motor; and
c) an AC motor.

17. (canceled)

18. A system according to claim 16, wherein the motor includes motor circuitry and wherein the motor monitors the current in the motor circuitry and stops the motor if the motor detects excess current in the motor circuitry.

19. (canceled)

20. A system according to claim 16, wherein:
the motor is configured to rotate a rotary drive;
the rotary drive is configured to move the platform between the lowered position and the raised position;
the plurality of lifting tethers are attached to the rotary drive;
the rotary drive includes a lifting tether spool the plurality of lifting tethers extending and/or retracting from the lifting tether spool in use;
when the rotary drive rotates in a first direction, the lifting tethers are configured to retract to thereby lift the platform; and
when the rotary drive rotates in a second direction. the lifting tethers are configured to extend to thereby lower the platform.

21-22. (canceled)

23. A system according to claim 20, wherein a coupling connector is connected to the lifting subsystem, and wherein operating the coupling connector is configured to raise and/or lower the platform.

24. A system according to claim 23, wherein at least one of the following is true:
a) the coupling connector is connected to the rotary drive and configured so that a user can operate the coupling connector to raise and/or lower the platform while the motor is deactivated; and
b) the coupling connector is configured to raise and/or lower the platform using at least one of:
i) a manual operator;
ii) an electrical operator;
iii) an externally powered electrical operator; and
iv) an electric drill.

25. (canceled)

26. A system according to claim 18, wherein:
the safety subsystem includes at least one limit switch and a limit switch bracket;
when the limit switch contacts the limit switch bracket the limit switch is configured to halt the motor;
the limit switch is attached to the frame and the at least one limit switch bracket is attached to at least one of lifting tethers; and
at least one of the following is true:
a) as the lifting subsystem lifts the platform above a pre-set raised position, the at least one limit switch contacts the limit switch bracket and halts the motor to prevent the platform from being lifted further; and
b) as the lifting subsystems lowers the platform below a pre-set lowered position, the at least one limit switch contacts the limit switch bracket and halts the motor to prevent the platform from being lowered further.

27-28. (canceled)

29. A system according to claim 18, wherein the lifting subsystem includes a first limit switch, a second limit switch and a limit switch bracket, and wherein:
a) as the lifting subsystem lifts the platform above a pre-set raised position, the first limit switch contacts the limit switch bracket and halts the motor to prevent the platform from being lifted further; and,
b) as the lifting subsystem lowers the platform below a pre-set lowered position, the second limit switch contacts the limit switch bracket and halts the motor to prevent the platform from being lowered further.

30. A system according to claim 26, wherein the contact between the limit switch and limit switch bracket creates an electrical signal that is sent to the motor which prevents the lifting subsystem from raising the platform above a pre-set raised position or lowering the platform below a pre-set lowered position.

31. A system according to claim 18, wherein the safety subsystem includes a rotary switch that is attached to at least one of the lifting tethers, and wherein:
a) as the lifting subsystem lifts the platform above a pre-set raised position, the rotary switch halts the motor to prevent the platform from being lifted further; and,
b) as the lifting subsystem lowers the platform below a pre-set lowered position, the rotary switch halts the motor to prevent the platform from being lowered further.

32. A system according to claim 31, wherein:
a) as the rotary switch rotates beyond a pre-set number of rotations in a first direction, the rotary switch creates an electrical signal that is sent to the motor which prevents the platform from being lifted further; and,
b) as the rotary switch rotates beyond a pre-set number of rotations in a second direction, the rotary switch creates an electrical signal that is sent to the motor which prevents the platform from being lowered further.

33. A ceiling mounted storage system for lifting objects stored on a platform, the system including:
a) the platform;
b) a frame configured to be mounted to a ceiling of a building;
c) a lifting subsystem attached to the frame and including a plurality of lifting tethers attached to the platform, the lifting subsystem being configured to move the platform between:
i) a lowered position whereby a user can place the objects on the platform to be stored; and,
ii) a raised position whereby the objects can be stored on the platform proximate to the ceiling; and,
d) a safety subsystem attached to the frame and including at least some of the plurality of safety tethers attached to the platform, the safety subsystem being configured to prevent lowering of the platform in the event of a failure in the lifting subsystem.

34. A system according to claim 33, wherein at least one of the following is true:
a) the platform includes a plurality of holes; and
b) the platform is configured to include:
i) a plurality of lifting attachment points corresponding to the plurality of lifting tethers; and
ii) a plurality of safety attachment points corresponding to the plurality of safety tethers.

35. (canceled)
